(19) United States
(12) Patent Application Publication
(10) Pub. No.: US 2010/0260399 A1
(43) Pub. Date: Oct. 14, 2010

(54) SCANNER DATA COLLECTION

(76) Inventors: Joseph Vilmos Hajnal, London (GB); Gianlorenzo Fagiolo, London (GB); Derek L.G. Hill, London (GB); Nicholas C. Fox, London (GB)

Correspondence Address: FRASER CLEMENS MARTIN & MILLER LLC, 28366 KENSINGTON LANE, PERRYSBURG, OH, 43551, US

(21) Appl. No.: 12/598,820

(22) PCT Filed: May 2, 2008
(86) PCT No.: PCT/GB08/01537

§ 371 Date: Jun. 10, 2010

(30) Foreign Application Priority Data
May 4, 2007 (GB) 0708712.5

(51) Int. Cl. G06T 7/00

(52) U.S. Cl. 382/131

(57) ABSTRACT

A scanning system comprises a scanner arranged to perform a scan of a subject to generate a scan data set; processing means arranged to receive the scan data set from the scanner, analyse the scan data set to determine whether it meets at least one criterion, and generate an output if it does not.

### FIELD OF THE INVENTION

The present invention relates to scanner data collection, including image data collection, in particular in medical applications. More specifically it relates to the checking of image data or other data to ensure that they meet one or more criteria, for example quality criteria or process criteria.

### BACKGROUND TO THE INVENTION

Medical imaging, including for example computed tomography (CT) imaging, and magnetic resonance (MR) imaging, is increasingly being used in multi-centre clinical trials. These trials require that images are acquired in standardised ways so that data from multiple subjects scanned at multiple sites can be aggregated. However, this paradigm is quite different from routine imaging for clinical purposes. In the latter, the examination is tailored to the individual under study and individual hospital teams often adopt local practices. Inter-site comparison thus becomes time and resource consuming. The fact that trial protocols so frequently deviate from local practice can lead to errors that result in loss of data and may necessitate recalling the subject, causing further time and resources to be expended. This problem can be further exacerbated by the common practice of having a central analysis centre to which all data is sent. It is not uncommon for there to be a significant delay between subject examination and data processing so that, even if errors are eventually discovered, it may be too late to recall the subject. Thus data can be irrevocably lost, possibly wasting a large previous investment in preparing and characterising the subject under study.

It is known, for example from U.S. Pat. No. 7,054,823 and U.S. Pat. No. 6,820,235, to redesign the workflow of the clinical trial to try to overcome these problems. The proposed methods involve the use of managed and guided data collection for the centres that participate in the trial. These solutions provide a detailed schedule to follow for each examination at each centre. However, this alone does not ensure that useful data is acquired as there are many sources of error that are directly associated with the conduct of the examination itself. These include incorrectly selecting data acquisition parameters, for example as a result of ambiguous labelling of pre-prepared examination protocols on the scanner console, poor subject positioning, errors in the entry of metadata related to the subject (name or identifier, weight, date of birth etc), scanner malfunction, subject motion.

### SUMMARY OF THE INVENTION

The present invention provides a scanning system comprising: a scanner arranged to perform a scan of a subject to generate a scan data set; and processing means arranged to receive the scan data set from the scanner, analyse the scan data set to determine whether it meets at least one criterion, and generate an output if it does not.

The system may further comprise a user interface arranged to generate an output in response to the output, which may be in the form' of an output signal.

The scanner may be arranged to generate scan output data from the scan and to include the scan output data in the scan data set. The scanner may be an MRI, ultrasound, Positron Emission Tomography (PET) scanner, Single Photon Emission Tomography (SPECT), optical tomography or spectroscopy scanner or X-ray scanner in which case the scan output data may be image data suitable for generating an image, or other data such as spectroscopic data which is not suitable for generating an image. Alternatively the scanner may be an electro-encephalography (EEG) or magneto-encephalography (MEG) system in which case the scan output data may be indicative of activity within the subject, in this case the brain, rather than for imaging the physical structure of the object.

The processing means may be local to or remote from the scanner, and may be located at the same site as the scanner, at a central site, or at some alternative location. The processing means may be a stand-alone computer, the scanner host itself, or a small portable device attached to the scanner.

The present invention can be used in either cross sectional trials in which each subject is only scanned once, or in longitudinal trials in which each patient or subject is scanned on several occasions over a long period of time. For longitudinal trials, it is preferable for the system to be able to check any new scan data to determine whether it relates to a subject for which scan data has already been obtained, or whether it relates to a new subject.

When administering to the subject a contrast agent according to a particular protocol, the system can check that the protocol has been followed regarding the timings or the expected effects of the contrast agent, or both.

When checking scans from a subject who has been previously scanned, the system can undertake additional checks, including more accurate assessment of changes of positioning of the subject between scans, or of data degradation resulting from instrument drift or subject motion.

The processing means may therefore be arranged to compare the scan data with stored scan data to derive an identity indicator for the subject. This identity indicator may simply confirm the identity of the subject as determined from other data, such as metadata, or it may be performed independently of any other identity check and then either just used to identify the subject or compared with other checks or indicators of identity.

The scanner may be arranged to communicate the data to the checking system for checking. The processing means is therefore preferably connected to the scanner, directly or indirectly, so that it can receive the scan data from the scanner. For example the checking system may be connected to the scanner control system. It may be connected by a network interface (such as Ethernet) or another scanner interface (such as a USB port or Bluetooth). It could be even embedded in the scanner control system software to obtain maximal integration. Alternatively data may be transferred between the scanner and the checking system by means of removable media such as a disk.

The present invention further provides a data collection system comprising a central analysis system, a plurality of scanners each having a checking system associated with it (which may be one checking system for scanner or a smaller number of shared checking systems), the checking system including processing means arranged to receive scan data from the scanner, analyse the scan data to determine whether it meets at least one criterion, and to generate an output signal if it does not, and a user interface arranged to receive the output signal and to generate an output in response to the output signal. Each of the checking systems may be arranged to generate an error report associated with the scan data, which can be sent to the central analysis system.

The present invention still further provides a method of collecting scan data, the method comprising: performing a scan of a subject to generate a scan data set, analysing the data set to determine whether it meets at least one criterion, and generating an output signal if it does not, and generating a user perceptible output in response to the output signal.

The method may further comprise any of the steps which the data collection system is arranged to carry out.

Preferred embodiments of the present invention will now be described by way of example only with reference to the accompanying drawings.

### BRIEF DESCRIPTION OF THE DRAWINGS

FIG. 1 is a diagrammatic representation of an scan data collection system according to an embodiment of the invention;

FIG. 2 is a flow diagram showing the process of setting up the system of FIG. 1;

FIG. 3 is a flow diagram showing the process of acquiring scan data using the system of FIG. 1; and

FIG. 4 is a flow diagram showing the process of checking scan data in the system of FIG. 1.

### DESCRIPTION OF THE PREFERRED EMBODIMENTS

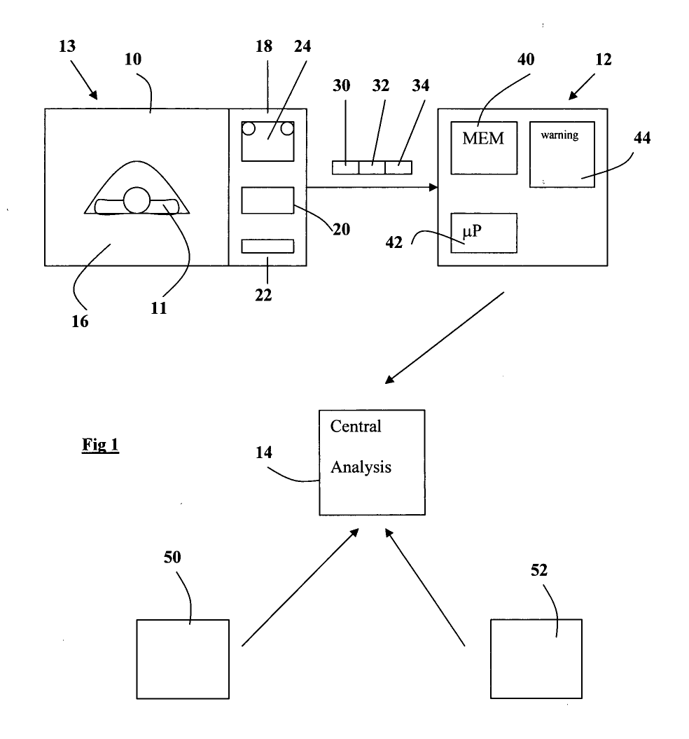

Referring to FIG. 1, a scan data collection system according to an embodiment of the invention for use in longitudinal trials comprises a scanner 10 arranged to scan a subject 11, a checking system 12 arranged to check data generated by the scanner 10, and a central analysis centre 14 arranged to receive checked data from the checking system 12. The subject may be a human, an animal, or a test object or “phantom” that is used to assess scanner performance. The scanner 10 and checking system 12 are local to each other and located at a scanning site 13. The scanner 10 comprises scanner hardware 16, and a control system 18 which includes a processor 20, a memory 22 and a user interface 24. In this embodiment the scanner is an MRI scanner, and the scan data is image data, although in other embodiments other types of scanners such as X-ray or ultrasound scanners could be used, and the scan data may not be image data. The memory 22 has stored in it a number of scanning protocols each of which defines a set of parameters for the scanner, so that a user can select an appropriate scanning protocol for the scan that is required. In this embodiment the parameters include the selection of scanner coils to be used, the magnetic field strength and the number and thickness of the slices that will make up the final three-dimensional image, the image contrast and relaxation parameters. They therefore define the volume that will be scanned and the manner in which the scan will be performed. The processor 20 is arranged to control the scanner hardware 16 to perform a scan according to the selected protocol, to receive raw image data from the scanner hardware 16 and process it, and to combine the processed image data 30 with protocol data 32 defining the scanning protocol that was used to generate the image. It is also arranged to receive subject ID data 34 input by a user via the user interface 24 and store that in a data file with the image and protocol data. Finally the scanner control system 18 is arranged to transmit the data file in a standard format, for example using the DICOM protocol, to the checking system 12.

The checking system 12 comprises a memory 40, a processor 42, and a user interface 44 arranged to generate an output display to communicate the results of the data check carried out by the checking system 12 to a user. The checking process will be described in detail below. However, as the checking system 12 is local to, and connected to, the scanner 10, it can receive the data file for each scan as soon as the scan is completed, store it in a database in its memory 40, and perform its checking and analysis in a matter of minutes or even seconds. The feedback to the user via the user interface 44 is therefore substantially in real time allowing any problems to be addressed while the subject is still present.

The central analysis centre 14 is arranged to receive the checked data from the checking system 12, and also to receive checked data from other scanning sites 50, 52 each of which includes a scanner and a local data checking system. In this embodiment the central analysis centre 14 is connected to each of the scanning sites so that data can be transmitted directly from the scanning sites to the central analysis centre 14. However it is also possible for the data to be transmitted to the central analysis centre indirectly, for example being downloaded to disk from the scanning site and then uploaded at the central analysis centre.

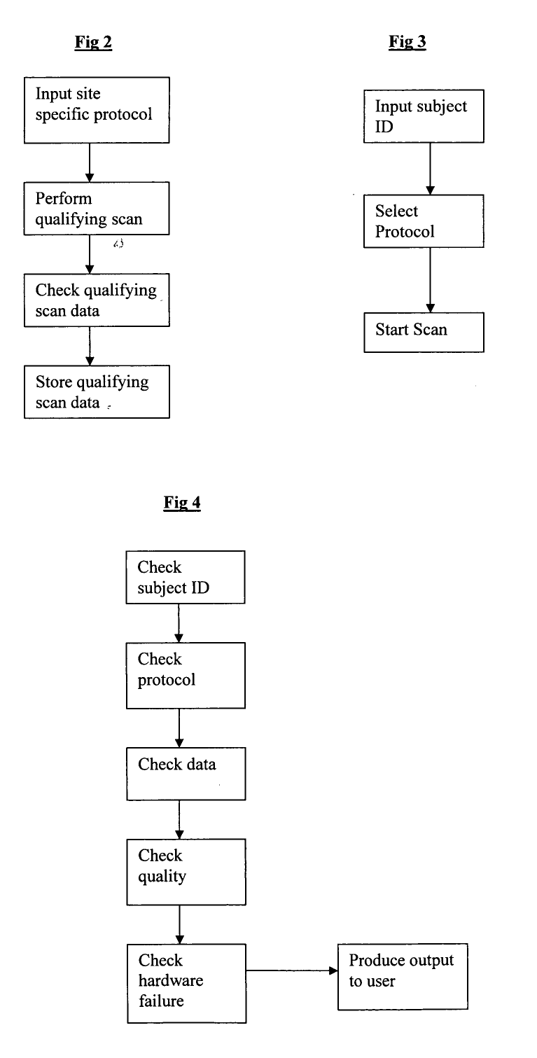

Referring to FIG. 2, at the start of a longitudinal clinical trial the checking system 12 is initially set up by forming, for each of the scanning sites 13, 50, 52, a group of qualification scan data sets, each corresponding to a specific scan protocol that can be performed at the respective site 13, 50, 52, or may have been obtained from another site or a computer simulation. In order to generate each qualification scan data set from the respective site, details of one available scan protocol for the scanner 10 are first either input via the user interface 24, or selected and retrieved from the scanner memory 22 at step 200. A scan is then performed on a subject at, step 202 using the selected protocol to generate scan data. The scan data is then checked for quality at step 204, typically by human checking or by a semi-automated or fully automatic process or a combination of these. Provided the quality is satisfactory the scan data and protocol data are combined to form the qualification data set which is stored in the database at step 206. In some cases the identity of the subject is not stored and the data set is stored in the database, in the memory 40 of the checking system, and used as a general qualification data set for checking scan data of all subjects. The identity of the subject may also be stored as part of the data set, which can then be used as a subject specific qualification data set for checking subsequent scan data of the same subject. In practice a general qualification data set (eg: from another site or a computer simulation) may be stored first, and then used to check the first scan data of any new subject which, if it is of sufficient quality, can then be stored as subject specific qualification scan data for that subject.

Referring to FIG. 3, during an examination when a subject is in the scanner and ready to be scanned, first at step 300 the identity of the subject is input to the scanner via the user interface 24. In this case the full name, date of birth and sex of the subject are entered and stored as subject identity data. The protocol to be used for the scan is then selected, again via the user interface 24, at step 302. This protocol will, as described above, include sufficient data to define all parameters of the scan so that any two scans performed using the same protocol will be performed in the same manner. Then at step 304 the scan is performed and the scan data acquired. The scan data, protocol data, and subject ID data are then combined and sent, for example as a single file such as a DICOM file, to the checking system 12.

The identity of the subject can in other embodiments be obtained from other sources to be received by the scanner. For example it may retrieved from a database of subjects, or obtained by a receiver or scanning device from an ID tag on the subject, or on the subject's patient notes or an ID card carried by the subject.

Referring to FIG. 4, on receiving the scan data file, the checking system is arranged to run a series of checking algorithms to perform a number of checks on the data. This is to check whether the scan meets a number of criteria and is therefore acceptable for the trial. These checks will now be described. The checks are shown in one specific order in FIG. 4 but it will be appreciated that the can be carried out in any order or in parallel.

In general, in a longitudinal trial, the checks are performed firstly to determine whether the subject can be identified as a subject for which data has already been collected, and then to check the quality of the data. If previous data is available for the subject then the new scan data is checked against the previous data. If no previous data is available then the new data is checked against qualification scan data.

A) Subject identification checks

Each subject's ID data (i.e. name, date of birth and sex) is stored in the database in a table. Moreover a secondary table relates each entry in the ID data table to a subject unique identifier (SUID), i.e. a code that uniquely identifies the subject. Thus the same subject might have different ID data entries (e.g. the name could be typed-in as either “Robert SMITH” or “SMITH, Robert”) but it will still be identified with a single SUID. In order to assign a consistent SUID the checking system goes through a series of stages.

There are three stages to the subject identification checking. The first stage uses intelligent text recognition on metadata, which in this case is the subject ID data that has been entered by the user. The checking is intelligent in that it overcomes typographical errors and changes of conventions, such as name formatting conventions. The user typed-in subject textual information is compared to subject information records of previously examined subjects, i.e. subjects for which subject specific data has been obtained and stored in the checking system. The previous subject data is found by querying the metadata database through a fuzzy search on the name field. In order to overcome changes of typing conventions, any text is decomposed into an alphabetically sorted list of small capital letter words with any apostrophes removed (e.g. “O'Riordan BROWN SMITH, Abraham” becomes the string list {‘abraham’, ‘brown’, ‘oriordan’, ‘smith’}). The fuzzy search is based on comparing each database entry to the new subject metadata using an ad-hoc list-of-strings distance derived from the Levenshtein (or ‘edit’) distance. The ad-hoc list-of-strings distance returns a number that characterises the number of edits (e.g. deleting, swapping, inserting, changing of characters) necessary to match each word of two compared string lists (i.e. if there are more matched words then the distance is smaller). Thus the result of the fuzzy search is a list of SUIDs ordered by ascending distance allowing a maximum number of editing errors per word of the subject name field, i.e. thus limiting the returned list to the most probable correct data. If a list of a plurality of potential corresponding previous data is found, the next stage of automatic subject brain-image-based identification is used to uniquely identify the subject. If no previous data is found for the subject, a new subject record for the subject is created together with a new SUID. The outcome of this first stage of check is presented to the user on the user interface 44 so that they can determine whether the result is as expected.

The second stage of the subject identification check is based on intelligent image recognition. In order to perform this check, once the subject has been identified using the metadata, previous scan data sets for the same subject, or group of possible subjects, using the same scanning protocol are searched for and identified by the checking system 12. If a suitable candidate previous image is identified then the image data of the newly scanned image and the candidate previous image are compared to check that they are sufficiently similar to confirm that the previous image is indeed from the same subject as the new image. This can be done using image registration, intensity normalisation and optimal thresholding. If they are found to correspond then the identity of the subject, or one of the list of possible subjects, as determined from the meta-data, is confirmed and the proper SUID is set. If the images are MR images of the head including the brain, such an automatic subject identification (APID) algorithm uses a comparison of automatically extracted brain data. One APID algorithm has been tested on several data sets and been found to be completely reliable in identifying previous scans of the same subject provided they have the same basic contrast properties (i.e. matches between T1w and T1w images or between T2w and T2w etc images are found). Again, if the APID algorithm does not confirm the identity of the subject found from the meta-data check, then the subject is entered on the database as a new subject (i.e. with a new SUID) and this is indicated to the user via the user interface 44.

This comparison of the image data with previous data for the same subject can also be used to check for fraud, as well as unintentional errors, to determine whether data has been falsely entered into a clinical trial data set. A hospital may for example submit the same subject data several times with different names so as to appear as unique subjects. Or an operator may try to doctor an image (e.g. by adding some noise etc so as to make it look different from an existing image) and submit it as new patient data. This can be detected by checking each new image data set against the previous scans of that person to verify that the image derives from the correct patient and not someone else. The same process will detect duplicate images where one has been deliberately altered in some way.

In the third stage of the subject identification the system performs, when it is in idle mode, a batch APID test between any new subject who have only one set of data in the database and all the subjects in the database (i.e. one set of scan per each unique subject). This third stage is performed in order to associate data belonging to the same subject (i.e. correcting the relative SUID associations) when the user typed-in information was completely wrong. The subject data that result as unique from this batch test is marked as checked and will not be checked again.

B) Protocol checks.

The checking system 12 is arranged to check protocol data embedded in the scan data files (such as DICOM files) of each scan to ensure that the scan parameters conform to internally stored parameters that are specific to the trial, the site and the particular scanning sequence. The parameters can be compared to the qualification scan. If the subject is a returning one then the scanning parameters are compared to the subject's previous scan, which can be either a subject specific qualification scan, or another previous scan of the same subject, in order to maintain (even in the case of a previous mistake) consistent data acquisition for each subject in a longitudinal trial.

When DICOM data is received by the checking system 12, the DICOM header is scanned for relevant fields that will identify the scanning sequence that was applied for that acquisition. Then the parameters of the received data are compared with the standard trial protocol and any deviations are reported on the dynamically updated report page. If the data received is from a returning subject belonging to the same trial the scanning parameters will be compared to the previously stored values used on earlier examinations of that subject. This ensures that the data is tested to ensure it is maximally consistent for each subject in a serial study. If differences are found between the protocol of the new scan and the protocol of corresponding previous scans, then a warning of this is provided via the user interface 44.

A protocol could require the use of an imaging contrast agent. Where pre- and post-contrast images are acquired, the scan time of the data labelled as post-contrast is checked versus the scan time of the data labelled as pre-contrast. If the time interval between pre-contrast and post-contrast does not respect the protocol specifications, for example if it is not within a predetermined range (e.g. the subject has been scanned to soon or too late), an appropriate warning is issued via the user interface 44.

C) Scan data checks.

The scan data is checked by the checking system 12 to ensure that it meets basic criteria. Firstly the scan data date and time are checked to check the freshness of the data. If the data is older than a predetermined period, for example 30 minutes, then the checking system 12 flags a warning to the user. This long delay between acquisition and data push might mean that the wrong data has been pushed from the scanner 10 to the checking system 12 or that the trial acquisition workflow has been disrupted for some reasons, or that the data being submitted is fraudulent (eg: the investigator is submitting historical scans as if they were prospectively acquired study subjects).

Secondly the data is checked for missing slices, by finding missing slices in the series of images received and by checking the protocol specification. When data is received in DICOM format, the header of each slice contains information about geometry, for example the position of the slice within the scanned volume. This is used to detect whether the data transfer was completed correctly without data loss. In fact even if no data loss was incurred, once the specific scanning sequence is recognised, in the protocol checking step, the checking system 12 is able to determine whether the slices received were the correct number. If the age of the scanning data is above an acceptable limit, or if it is detected that one or more slices are missing, then an appropriate warning is issued via the user interface 44.

D) Scan data quality checks.

Once the scan data is received and recognised, the image data for each sequence is extracted and reconstructed into a multi-slice stack or volume as appropriate. A number of checks are then carried out on the image data to ensure that the image is of a satisfactory quality for the trial.

The position and angulation (orientation) of the target anatomy in the field of view (FoV) are checked. To do this the image is aligned to a reference image, e.g. one of the qualification images, and the alignment parameters (e.g. relative angulations and linear shifts) are stored. If these parameters are outside specific ranges the scanner user is alerted by a warning via the user interface 44. In the case of head scans the brain image data is automatically extracted and the brain boundaries are compared to the edges of the FoV. When these boundaries are too close to the edges of the FoV, the scanner user is prompted with a warning. One reason for checking the positioning of the subject is that the imaging gradient fields are linear only in a defined region of the scanner. If the subject is not positioned within such region, then the acquired image will present non-uniform image distortions. Therefore the position of the subject in the scanner is computed. This is performed by computing the coordinates of the centre of gravity of the subject's brain relative to the scanner's gradient iso-centre. The absolute coordinates of the scanner's gradient iso-centre are retrieved from the dicom header information, and the centre of gravity of the brain is determined from the image data. The resulting coordinates are stored. If the subject has already been scanned, then the centre of gravity coordinates are compared to the centre of gravity coordinates of the previous scan by computing a component-by-component difference. If the resulting difference in coordinates, in particular in the head-to-foot direction, are outside a specific range the scanner user is alerted by a warning via the user interface 44. This can be useful as the feedback to the user can indicate that the subject needs to be re-positioned and another scan performed.

Geometrical errors in the scan data may be detected by identifying multiple corresponding locations in the acquired scan data and a reference scan (such as one of the qualification scans), and determining whether the deviations in the relative locations of these corresponding locations in the acquired and reference scans are outside a predetermined threshold. The detection of these corresponding locations could be using a feature detection method or non-rigid image registration algorithm. Minor changes in the shape of the subject measured from these corresponding locations may be an expected consequence of normal variability, disease progression or treatment response, but larger changes could indicate instrument errors which need to be reported to the user. Where the subject is a phantom image, the phantom may have features built into it designed to assess different aspects of system performance which can all be assessed by the system.

Motion artefacts in the scan data are detected and classified with assessment of the magnitude of the detected artefacts relative to prescribed study requirements. Also aliasing artefacts are similarly detected, classified and assessed.

Signal to noise ratio (SNR) assessment and contrast to noise ratio (CNR) assessment are also performed, with the SNR and CNR being assessed relative to prescribed study requirements.

The SNR, CNR and artefact quality checks are performed using the standard deviation of signals in uniform tissue areas to assess signal to noise ratio and artefact power. This provides information both on intrinsic scan data quality and on scanner faults, which frequently change either the signal or the noise level, or both. Since modern scanners frequently do not yield images with uniform signal intensity properties across the field of view, this embodiment uses methods that determine the standard deviation of signals on suitable subtraction images. For returning subjects, these subtraction images can be computed from the difference between the current and previous scans after image alignment. Such comparisons are made in regions of the difference images where there are no detectable. In the case of the image data coming from the first visit of a new subject, the same kind of comparison is performed, but using reference data restricted to regions of homogeneous tissue which will be substantially the same in all subjects. For this purpose in brain studies a core of white matter in the brain can be experimentally identified that is common to all subjects within a relevant database of comparison subjects for the trial in question. The core of voxels corresponding to this core of white matter can be used to make subtraction images and so facilitate the required tests.

Motion artefacts are captured by analysing the distribution of the image's edge intensities. An empirical parametric distribution can be designed to model the image edge intensity distribution within the brain. The parameters of the empirical distribution can be correlated to the effect of motion on real images. These parameters can be studied in a training stage by simulating on the computer the effects of different levels of subject motion on a set of good images scanned with a particular hardware. This training step generates good quality image ranges for the model distribution parameters.

When a new image is analysed, the parameters of the empirical distribution are fitted to the image's edge intensity distribution using maximum likelihood estimation. If the fitted parameters of the new image are outside the ranges learned in the training stage then the scanner user is alerted by a warning via the user interface 44. The warning reports a qualitative measure of the distance of the fitted parameters from the estimated good-quality image parameters. Such distance is correlated to the amount of motion detected.

When a contrast agent has been used, the post-contrast agent image is checked versus the pre-contrast image, or to previously available data, in order to compare changes in the post-contrast image with, an expected amount of signal changes. These signal change checks can be made separately in blood vessels (an assessment of the arterial input function, AIF, or in tissue). If the signal changes are outside predetermined default ranges (e.g: if the peak to 60 second post peak ratio of the AIF is <2), the checking system will issue a warning on the user interface 44. Once warned, the user can check to determine if any action can be taken to obtain more useful data—e.g. if the contrast agent had not been injected, the procedure could be re-run to obtain post contrast data.

Once all of the checks have been carried out on the scan data set by the checking system 12, and any problems or potential problems with the data identified, and indicated to the user via the user interface, a decision can be taken whether the scan has been performed satisfactorily or not. If it has not, then a further scan can be carried out. For example, if the subject identification checks indicate that the subject of the scan, as identified from the scan output data, does not match the input ID data, then the user can check both the identity of the subject and the ID data that has been input, and if appropriate correct any errors. If the corrections are input by the user these can be used to update the scan data file. If the protocol checks determine that the scan protocol does not match the required protocol or the protocol previously used for the same subject, then a further scan can be performed with the correct protocol. If the scan data checks indicate problems with the scan data, then this may indicate that the scanner has not been set up correctly, in which case the user may be able to correct the set up and perform a repeat scan. In some cases it may indicate a fault with the scanner which requires maintenance, in which case the user may be required to call for an engineer to repair it. This may enable a repeat scan to be performed. Alternatively, the user may need to perform a repeat scan on a different scanner if one is available at the same site. If the checking system determines that the position of the subject within the scanning area is not correct or not consistent with previous scans, then this can be indicated to the user, and a further scan carried out with the subject re-positioned to the correct position. In any of these cases, if a repeat scan is performed then the scan data for the repeat scan will be forwarded to the checking system for the same checking process. If the scan data is satisfactory and meets all the relevant criteria, then the scan data is stored in the database of the checking system ready to be sent on to the central analysis system 14, and an indication of this is provided via the user interface.

In some cases, the checking system may be arranged, if one or more of the criteria are not met, to send a signal back to the scanner requesting a repeat scan, and the scanner may be arranged to perform a repeat scan in response to that automatic request. In this case no feedback to the user is needed, although it might be desirable.

It is often important that the checking system perform the necessary checks within a timescale that is short enough for a repeat scan to be performed. For some studies, this should be before the subject has left the scanning site, and preferably before the subject has even been removed from the scanner. Therefore the checking system is arranged to receive the scan data from the scanner as it is generated, and to perform the checks as soon as it receives the data. In some cases this can enable the checking to be carried out in real time and the feedback be given in real time, so there is no significant delay between completion of the scan and the user receiving the feedback. This can enable the checking, and any necessary repeat scans, to be performed while the subject is still in the same position as which the scan is carried out. In other cases the checking and feedback may be completed within a minute, or within ten minutes, of completion of the scan. This means that when a subject arrives at the scanning site, a scan can be performed, the scan data checked, any necessary repeat scans performed, for example with different scanner protocol or a re-adjustment of the position of the subject, so that a satisfactory scan is obtained before the subject leaves the scanner site. In other cases it may be sufficient for the checking to be performed over longer timescales, for example after the patient has left the scanning location. In some studies (eg: where longitudinal scans are several months apart), a delay of a small number of days is permitted in the performance of the checks, as the subject can be invited back on a separate day for a repeat scan without loss of the data point to the trial.

The transfer of scan data files from the checking system 12 to the central analysis system 14 can be performed in a number of ways. In the simplest process, the scan data files are simply stored to disk and transferred manually. However in this embodiment the checking system 12 is connected to the analysis system 14 and is arranged to transmit the files in a regular report performed at regular time intervals. Also the checking system 12 is arranged, as part of its checking process, to distinguish between faults or errors which make the scan data useless, and faults or errors which simply need to be communicated to the central analysis system. All files that are transmitted include an error report which identifies any problems that the checking system 12 has identified. They can then be taken into account when the data is being analysed. In some cases it may be preferred for all scan data files to be transmitted, so that the central analysis system 14 can monitor all problems with each of the scanning sites. This can then be used, for example, in selecting sites for further trials.

In summary the checking system 12 provides a powerful range of tests that together allow most of the common errors that occur in image based clinical trials to be identified and frequently corrected before the subject leaves the scanning suite. Data is passed to the checking system, e.g. via the industry standard DICOM format, which can be achieved without undue interruption to work flow. The results of this analysis are displayed on a dynamically update web page that can be used by scanner operators to identify errors while the subject is still in the scanner, when they can still be corrected. The resulting data is stored on the checking system and can be automatically transferred to a central facility for further analysis. The aggregated data from all sites in a trial, or from all sites in multiple trials can be used to assess the relative ability of sites to adhere to the protocol, to identify scope for quality improvements e.g: through improved training, and to detect patterns of behaviour that could indicate fraud (e.g: submission of historic, manipulated or made-up data as if it were trial data).

The checking system has been tested at three clinical sites participating in a multi centre trial and has been found to be extremely effective in detecting errors and alerting the scanner operators that these have occurred. The errors detected have included a number of protocol parameter value violations and some subtle contrast changes that were missed by the operators at the time. Feedback information is available within seconds and this helps ensure that correction strategies can be rapidly put in place.

It will be appreciated that many variations to the embodiment described above can be made, some of which will now be discussed.

The subject of the scan may be a part of a human body, such as the brain as in the embodiments described, another internal organ or a joint.

Alternatively it may be the whole or part of an animal body. The subject may be alive or dead, or may be inanimate, for example a ‘phantom’ which is a shaped object used for testing scanner equipment.

Instead of comprising a separate computer system, the checking system can be part of the scanner system. For example it may take the form of a virtual computer operating on the same hardware as the scanner control system, but separated from it functionally.

1. A scanning system comprising:
a scanner arranged to perform a scan of a subject to generate a scan data set; and
a processor arranged to define at least one criterion, receive the scan data set from the scanner, analyze the scan data set to determine whether it meets the at least one criterion, and generate an output if it does not.

2. A system according to claim 1 further comprising a user interface arranged to generate a user identifiable output in response to the output from the processor.

3. A system according to claim 1 wherein the scanner is arranged to generate scan output data from the scan and to include the scan output data in the scan data set.

4. A system according to claim 3 wherein the processor is arranged to analyze the scan output data to determine whether it meets the at least one criterion.

5. A system according to claim 4 further comprising a memory having scan output data stored therein, wherein the processor is arranged to compare the scan output data with the stored scan output data to derive an identity indicator for the subject.

6. A system according to claim 5 wherein the scanner or the processor is arranged to receive subject identity data.

7. A system according to claim 6 wherein the scanner is arranged to include the subject identity data in the scan data set.

8. A system according to claim 6 wherein the processor is arranged to check for correspondence between the scan output data and the subject identity data.

9. A system according to claim 3 further comprising a memory arranged to have previously stored scan data sets therein, wherein the processor is arranged to compare at least a part of the scan data set with at least a part of one of the previously stored scan data sets, and the at least one criterion relates to the comparison.

10. A system according to claim 9 wherein the previously stored scan data set is specific to at least one of the scanner, the type of scan being performed, the part of the subject being scanned, and the subject.

11. A system according to claim 1 wherein the scanner is arranged to record process data indicative of at least one parameter of at least one of a scan process, a data acquisition process, and a data pre-processing process associated with the scan, and to include the process data in the scan data.

12. A system according to claim 11 wherein the processor is arranged to compare the scan process data with stored process data to determine whether the scan was performed according to a predetermined process.

13. A system according to claim 12 wherein the stored process data has a subject identity associated with it and the processor is arranged to identify the subject of the scan, and to check for correspondence between the scan process data and stored process data associated with the same subject.

14. A system according to claim 1 wherein the criterion is whether the subject was correctly located within the scanner during the scan.

15. A system according to claim 14 wherein the processor is arranged to determine from the scan data set the position of the subject relative to the position of a field of the scanner.

16. A system according to claim 1 wherein the scan data set defines a distribution of edge intensities, and the system further comprises a memory having a reference edge intensity distribution, and the processor is arranged to make a comparison between the distribution of edge intensities defined by the scan data set and the reference edge intensity distribution, and the criterion relates to the comparison.

17. A system according to claim 1 wherein the processor is arranged to define a measure of movement of the subject during the scan, and the criterion relates to the measure of movement.

18. A system according to claim 1 wherein the processor is arranged to compare the scan data with scan data from a previous scan of the same subject, and the at least one criterion relates to the comparison.

19. A system according to claim 18 wherein the processor is arranged to determine the difference between the two scan data sets and the criterion relates to whether the differences are within a predetermined range.

20. A system according to claim 1 wherein the processor is arranged to identify any of the criteria that are not met, and to record them in a report associated with the scan data set.

21. A data collection system comprising a central analysis system, a plurality of scanners each having a checking system associated with it, the checking system including a processor arranged to receive scan data from the scanner, analyze the scan data to determine whether it meets at least one criterion, and to generate an output if it does not.

22. A method of collecting scan data, the method comprising:
performing a scan of a subject to generate a scan data set,
analyzing the data set to determine whether it meets at least one criterion, and generating an output if it does not.

23. A method according to claim 22 further comprising generating a user perceptible output in response to the output.

24. A method according to claim 22 including generating scan output data from the scan and including the scan output data in the scan data set.

25. A method according to claim 24 including analyzing the scan output data to determine whether it meets the at least one criterion.

26. A method according to claim 25 including comparing the scan output data with stored scan output data to derive an identity indicator for the subject.

27. A method according to claim 22 including performing a repeat scan in response to the output.

28. A method according to claim 27 including re-positioning the subject for the repeat scan.

29. A method according to claim 27 including changing a parameter of the scan for the repeat scan.

30. A method according to any claim 22 wherein the scan is performed with the subject in a scan position and the output is generated while the subject is still in the scan position.
